(19) United States
(12) Patent Application Publication
(10) Pub. No.: US 2016/0300056 A1
(43) Pub. Date: Oct. 13, 2016

(54) Processor, Processing Device, and Method for Creating Program

(71) Applicant: ATT CONSULTING CO., LTD., Tokyo (JP)

(72) Inventors: Yoshiki Tashiro, Tokyo (JP); Narihiro Ikeda, Tokyo (JP)

(21) Appl. No.: 14/892,568

(22) PCT Filed: Sep. 24, 2013
(86) PCT No.: PCT/JP2013/075601

§ 371 Date: Nov. 19, 2015

(51) Int. Cl. G06F 21/52; G06F 13/24

(52) U.S. Cl. CPC G06F 21/52; G06F 13/24; G06F 2221/2123; G06F 2221/034

(57) ABSTRACT

An object of the present invention is to provide a technique to reliably prevent execution of a malicious program due to a buffer overflow. In the present invention, a start address and an end address of each area on a memory is obtained, a return instruction in an assembly language is detected, a return address instructed as an operand of the return instruction is obtained, it is determined which area on the memory is instructed by the return address, and the execution of the malicious program beforehand is prevented beforehand if the return address instructs an illegal area on the memory.

### BACKGROUND OF THE INVENTION

1. Technical Field

The present invention relates to a technology to prevent execution of a malicious (or illegal) program with respect to a buffer overflow.

2. Background Art

Before execution of main processing of an application program on a computer, a start-up routine operates and a stack area is allocated on a memory. The stack area is a memory area to temporarily store used variables, such as return values of functions. If data is written exceeding an upper limit of a buffer area allocated in the stack area, data in an area other than the buffer area in the stack area may be overwritten. This is referred to as a buffer overflow.

It is referred to as a buffer overflow attack to execute a malicious program indicated by a rewritten return address, which used to be a once-stored return address in the stack area and is now rewritten by intentionally causing the buffer overflow.

The following technologies have been disclosed as a technology to deal with the buffer overflow and the buffer overflow attack.

Patent Document 1 describes an analysis method for providing a program developer with analysis information, by collecting such information, that is necessary for correcting the program causing the buffer overflow.

Patent Document 2 describes a method of detecting the buffer overflow by allocating a dummy memory area with an adjacent address just before or just after the buffer memory area.

### PRIOR ART DOCUMENTS: PATENT DOCUMENTS

Patent Document 1: Japanese Unexamined Patent Application Publication No. 2006-053760.

Patent Document 2: Japanese Unexamined Patent Application Publication No. 2009-259078.

### BRIEF SUMMARY OF THE INVENTION

Problems to be Solved by the Invention. However, the method like Patent Document 1, which collects the analysis information required to correct the program causing the buffer overflow to deal with the correction of the program, can deal with only the already-known attacks, but cannot deal with unknown attacks such that there is an issue in the certainty of detection.

In addition, the method still has another issue that the correction operation to the program by the program developer is necessary on a timely basis.

The method described in Patent Document 2, which allocates a dummy memory area with an adjacent address before or after the buffer memory area to detect the buffer overflow, is quite effective against an attack that continuously alters the memory area, but cannot deal with an adroit attack that rewrites the return address with the address of a pinpoint accuracy such that there still is an issue in the certainty of detection.

In addition, such processing is added to the program as the source program is analyzed before compiling the program, but this method relies on the high-level language to be used in order to make the program such that there is an issue since it is necessary to take this method individually for each kind of high-level language and it is also required to keep up with the modification of each kind of high-level language.

The present invention has been made in view of these circumstances and it is an object of the present invention to provide a technology to reliably prevent execution of a malicious program with respect to the buffer overflow without any program correction work for the treatment by a program developer and without dependence on the high-level language used for the program.

Means for Solving the Problems. To solve the above-described problem, the present invention includes a processor having a function to allocate (or assign) a process space in a memory before executing main processing, the processor executing processing including a return instruction for returning to a return destination in any area in the process space, the processor comprising: means for obtaining first specification information for specifying a first area in the process space; first storage means for storing the first specification information; return instruction detecting means for detecting a return instruction from the processing in advance; means for obtaining address information for specifying a place of returning by the return instruction; means for determining whether the place specified by the address information is in the first area or not based on the first specification information; and means for interrupting (or halting) the processing if the determining means determines that the specified place is in the first area.

In the present invention, the first storage means is characterized by including a register.

And in the present invention, the first area is characterized by comprising an area other than a text area or a shared library in the process space.

And in the present invention, the first area is characterized by comprising a stack area in the process space.

To solve the above-described problems, in the present invention, a processing device includes the processor having the above-described features, the memory, and communication means to enable communication between the processor and the memory.

In order to solve the above-described problem, the present invention is directed to a method of making (or creating) an executable program using a computer, the executable program being configured to implement a method to cause a processor to execute processing, the processor having a function to allocate a process space in a memory before executing main processing, the processor executing the processing including a return instruction for returning to a return destination in any area in the process space, the method comprising the computer's rewriting the return instruction so as to cause the processor to implement the steps of: obtaining first specification information for specifying a first area in the process space; storing the first specification information; detecting a return instruction from the processing in advance; obtaining address information for specifying a place of returning by the return instruction; determining whether the place specified by the address information is in the first area or not based on the first specification information; and interrupting the processing by the processor if the determining means determines that the specified place is in the first area.

In the present invention, the method is also characterized by comprising the steps of: converting the executable program into an assembly language before the step of rewriting; wherein the steep of rewriting of the return instruction is implemented in the assembly language in the step of rewriting; and converting the converted executable program into an executable format after the step of rewriting.

Effects of the Invention. According to the present invention, the execution of a malicious program due to a buffer overflow may be reliably prevented without having a program developer perform a program correction work in order to deal with the malicious program or without relying of a high-level language used for the program.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 is a logical schematic diagram of a process space in the case where a program described in C language operates on a computer.

FIG. 2 is a schematic diagram of stack areas illustrating an example where a return address is rewritten to an address of a malicious program code due to a buffer overflow.

FIG. 3 is an example of a memory map with an example of Linux (registered trademark).

FIG. 4 is a block diagram illustrating a configuration of a processing device (Embodiment 1 and Embodiment 2).

FIG. 5 is a conceptual diagram of a kernel that couples hardware and an application program on a general computer.

FIG. 6 is a flowchart showing a procedure for obtaining start addresses and end addresses of a text area and a shared library in a start-up routine (Embodiment 1).

FIG. 7 is a flowchart showing a procedure for processing executed by an operating unit (Embodiment 1).

FIG. 8 is a flowchart showing a procedure for obtaining a start address and an end address of a stack area in the start-up routine (Embodiment 2).

FIG. 9 is a flowchart showing a procedure for processing executed by the operating unit (Embodiment 2).

FIG. 10 is a block diagram illustrating a configuration of a processing device (Embodiment 3 and Embodiment 4).

FIG. 11 is a flowchart showing a procedure where a memory map obtaining unit obtains the start addresses and the end addresses of the text area and the shared library (Embodiment 3).

FIG. 12 is a flowchart showing a procedure for processing executed by a disassembler, an instruction insertion unit, and an assembler (Embodiment 3).

FIG. 13 is a flowchart showing the procedure for processing executed by the disassembler, the instruction insertion unit, and the assembler (Embodiment 3).

FIG. 14 is a flowchart showing a procedure where the memory map obtaining unit obtains the start address and the end address of the stack area (Embodiment 4).

FIG. 15 is a flowchart showing a procedure for processing executed by the disassembler, the instruction insertion unit, and the assembler (Embodiment 4).

### DETAILED DESCRIPTION OF THE INVENTION

With respect to embodiments of the present invention, details will be explained with reference to the drawings.

Firstly, a buffer overflow and a buffer overflow attack are explained in the following.

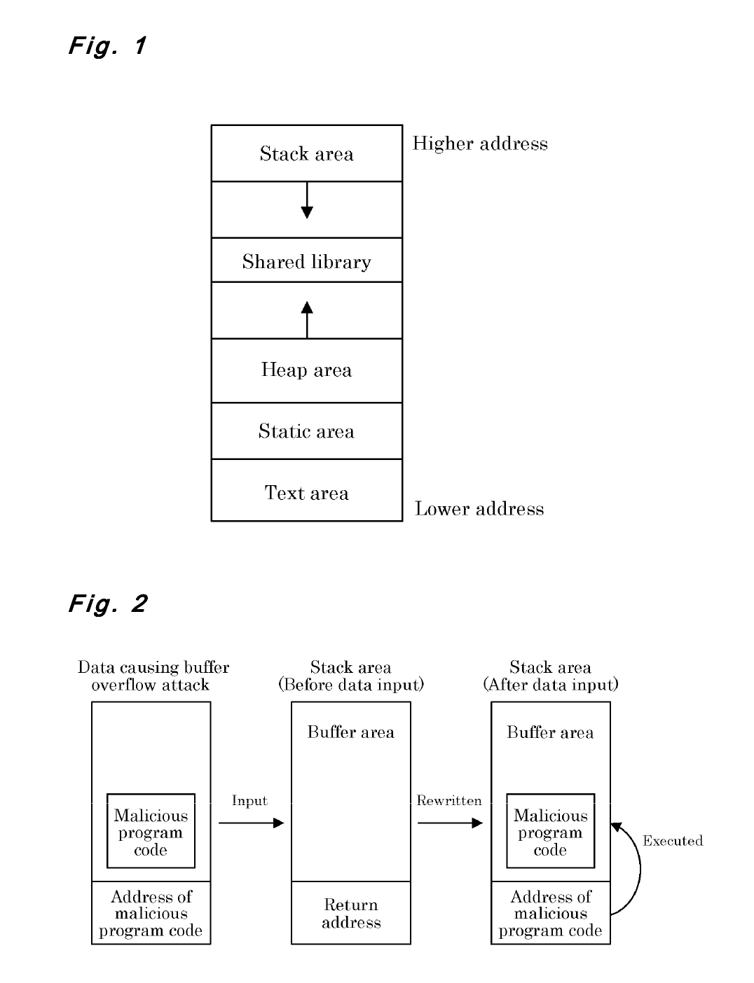

FIG. 1 is a logical schematic diagram of a process space in the case where a program described in C language operates on a computer. The process space means a virtual address space allocated (or assigned) for a process in an address space by processing of an operating system in a processor. The address space means a memory space accessible with a sequence of memory addresses. As illustrated in FIG. 1, from a lower address to a higher address in the process space, a text area, a static area, a heap area, a shared library, and a stack area are secured. The text area stores programs translated in machine language. The static area stores static variables such as global variables. The heap area is used to dynamically manage the memory. The shared library stores a library used in common by a plurality of programs. The stack area stores data temporarily used for a return value of a function and a function such as a local variable.

Here, the example where the program is described in C language is shown. However, the same applies to the case where the program is described in another language with which a memory operation similar to the C language is performed.

FIG. 2 is a schematic diagram of the stack areas illustrating an example where a return address is rewritten to an address of a malicious program code due to a buffer overflow. A buffer area is secured in the stack area in order to temporarily store data used for the function such as a local variable. If data is written in an area exceeding the upper limit of the buffer area by the program operation, data in such an area other than the buffer area in the stack area will be overwritten. This is referred to as the buffer overflow.

Most data stored in the buffer area are what is read from the outside of the program, such as an input from a file, an input via a network, and an input from a keyboard. As illustrated in FIG. 2, it is referred to as a buffer overflow attack to rewrite the return address having been stored in the stack area so as to execute the malicious program by intentionally causing the buffer overflow by making the buffer area and an area exceeding the upper limit of the buffer area read and take therein the data including the malicious program from the outside.

Since the destination instructed with the return address is a program or a library in executable format, as illustrated in FIG. 1, the return address is required to be within the range of the text area or the shared library.

Meanwhile, the return address rewritten by the buffer overflow attack instructs an area in which the programs should not be present originally. FIG. 2 illustrates an example where the malicious program has overwritten data in the stack area in which the program should not be present originally, and then the malicious program is executed.

In this embodiment, the start address and the end address of each area in the process space are obtained from information indicated in a memory map. The memory map signifies a file including mapping information of a data structure indicative of a state of a process in the kernel of the operating system. For example, in Linux (registered trademark), the memory map is present under the /proc directory for each process ID.

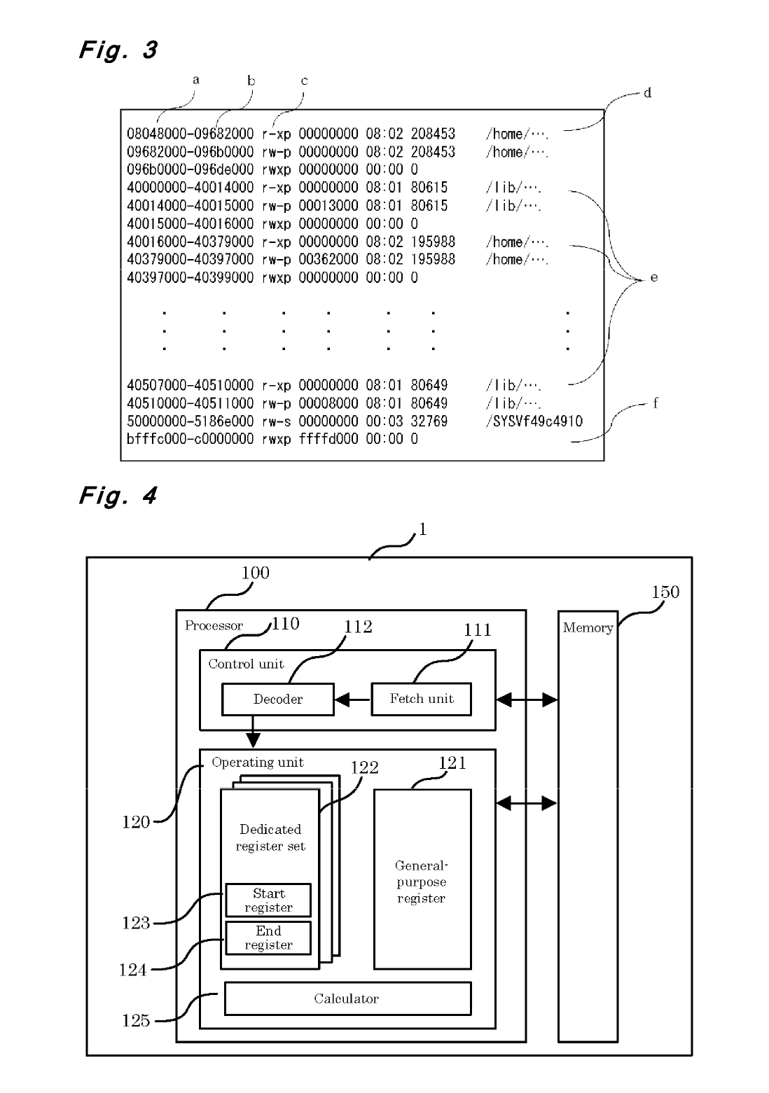

FIG. 3 is an example of the memory map with respect to Linux (registered trademark). Reference numeral a denotes the start address, and reference numeral b denotes the end address. As illustrated in FIG. 1, the stack area is configured as a consecutive area from a certain address to the highest address (reference numeral f). Since access authorities (reference numeral c) for both a text area (reference numeral d) and a shared library (reference numeral e) are “r-x” (readable, unwritable, and executable), the text area and the shared library may be identified.

Since the accurate start address and the accurate end address of each area in the process space may be obtained by the memory map, reliability of the processing is improved.

In an embodiment to be described in the following, Linux (registered trademark) is explained as an example of the operating system, but the operating system may be another operating system which can obtain the memory map.

### Embodiment 1

In this embodiment, a processing device is configured to include another area other than the text area or the shared library as a first area. The processing device is characterized in that the processor obtains the memory map by executing the start-up routine; includes a plurality of sets of dedicated register sets that store the start addresses and the end addresses of the text area and the shared library obtained from the information indicated by the memory map; and includes an internal instruction, which executes processing means.

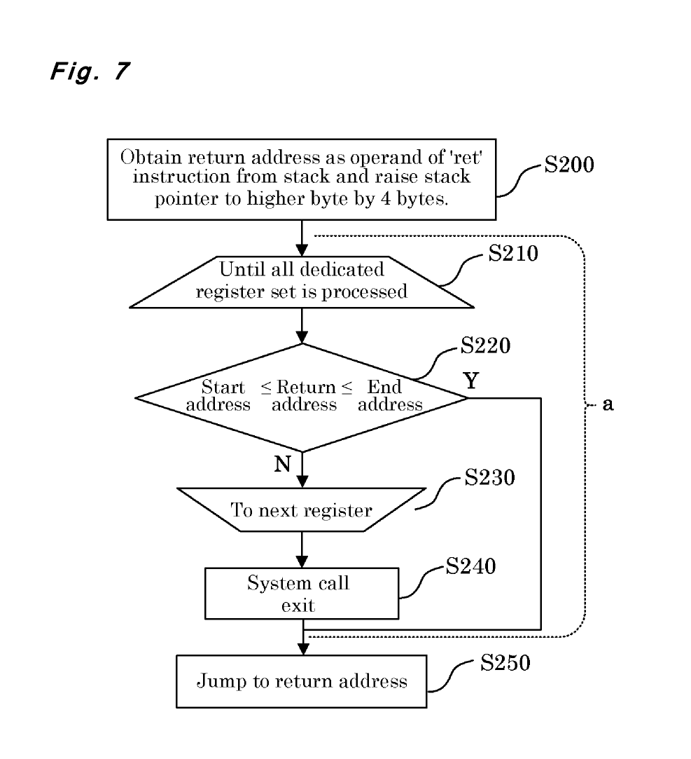

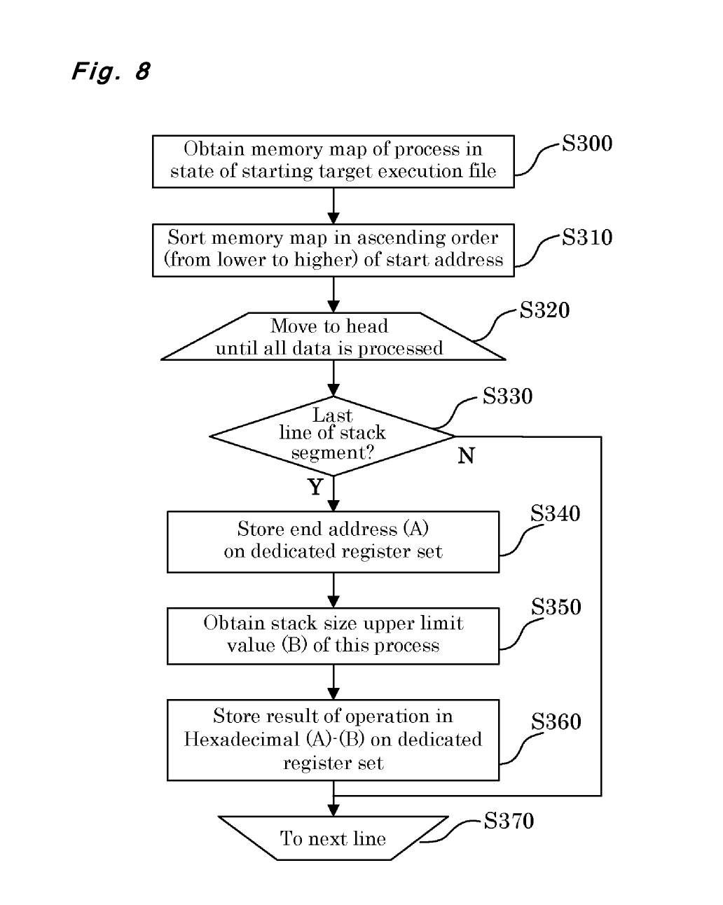

The internal instruction is a machine language instruction that executes a processing flow, which is illustrated in FIG. 7, corresponding to a mnemonic on a return instruction (a RET instruction) in the assembly language. In the following, with respect to description of an embodiment, the return instruction in the assembly language is described as RET instruction.

FIG. 4 is a block diagram illustrating a configuration of a processing device 1. A processor 100 according to this embodiment includes a dedicated register set 122 constituted of a plurality of sets of start registers 123 to store the start addresses of the text area and the shared library and end registers 124 to store the end addresses of the text area and the shared library in addition to a general-purpose register 121.

The processing device 1 can include, an input/output device with the outside, a storage device, a display device, or the like (not shown).

The following describes the start-up routine.

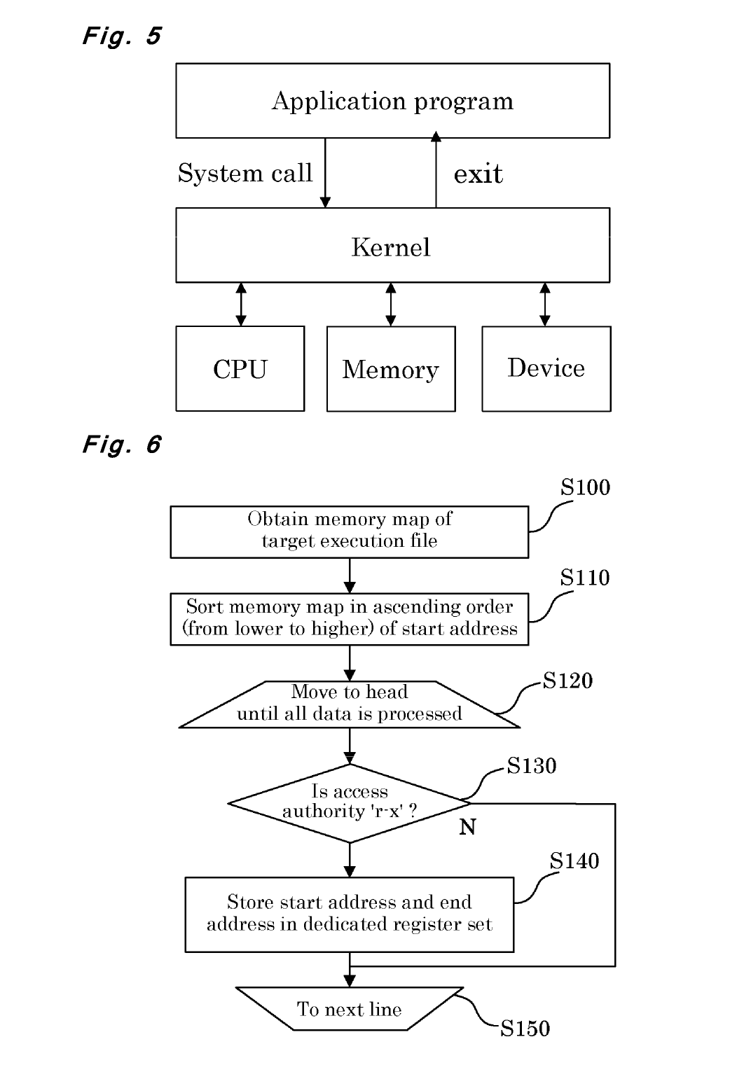

FIG. 5 is a conceptual diagram of a kernel that couples the hardware and the application program in the general computer. For example, when the application program instructs the processor to execute the program, a system call passes the processing to the kernel, and the processing is returned upon termination of the processing (exit). The start-up routine is a kind of the kernel and, before executing the main processing of the application program, the start-up routine is linked to the execution file of the application program to set the stack, initialize the library, and so on.

In this embodiment, it is characterized in that the start-up routine obtains the start addresses and the end addresses of the text area and the shared library on the memory from the information indicated by the memory map before executing the main processing of the application program.

In the following, a processing step of obtaining the start addresses and the end addresses of the text area and the shared library from the information indicated by the memory map will be explained.

FIG. 6 shows a flowchart illustrating a procedure that the processing device 1, which is illustrated in FIG. 4, obtains the start addresses and the end addresses of the text area and the shared library in the start-up routine. In this embodiment, the start addresses and the end addresses of the text area and the shared library are first specification information.

Before executing the main processing of the application program, the processing device 1 executes the start-up routine linked to the execution file of the application program and obtains the memory map of the execution file of the application program (Step S100). The memory map is sorted in an ascending order, from the lower to higher start address (Step S110).

The memory map includes the information shown in FIG. 3. The determination is executed in an order from the head of the memory map (Step S120). In the case of the access authority being “r-x” (readable, unwritable, and executable), it is determined that the area is the text area or the shared library (Step S130) such that the start address and the end address are stored in the start register 123 and the end register 124 in the identical dedicated register set 122 store, respectively (Step S140). In this embodiment, the register set is first storage means.

Next, FIG. 7 shows a flowchart illustrating a procedure for processing executed by an operating unit 120 in the processor 100, which is illustrated in FIG. 4. Compared with the processing by the RET instruction, which allows a return destination to return to any area in the process space, the processing of the part denoted by a in FIG. 7 is added to the processing of the RET instruction in this embodiment.

Next, processing steps of detecting the RET instruction and obtaining the return address instructed as the operand will be explained.

With the processing device 1 illustrated in FIG. 4, the application program loaded from the input/output device with the outside and the storage device is stored as an execution instruction translated into the machine language in the text area in a memory 150. In a control unit 110 of the processor 100, a fetch 111 obtains the execution instruction and control information is transmitted to the operating unit 120 through a decoder 112. In this respect, in the case where the operating unit 120 detects the RET instruction, the control unit 110 obtains the return address instructed as the operand of the RET instruction.

Next, a processing step of determining which area on the memory is instructed by the return address will be explained.

After the operating unit 120 in the processing device 1, which is illustrated in FIG. 4, obtains the return address instructed as the operand of the RET instruction (Step S200), it is determined whether the return address is within the range between the start address and the end address stored in the start register 123 and the end register 124 in the same dedicated register set 122 or not (Step S220).

Next, a processing step of preventing the execution of a malicious program beforehand in the case where the return address instructs an illegal area on the memory.

In the case where the instruction destination of the return address is in the text area or the shared library, the processing jumps to the return address (Step S250). If the instruction destination of the return address is in an area other than the text area or the shared library (the first area), the execution of the program is forcibly terminated (Step S240). The case where the instruction destination of the return address is in the area other than the text area or the shared library (the first area) is the case where the return address is not in the range from the start address to the end address of the text area or not in the range from the start address to the end address of the shared library.

As described above, according to this embodiment, in the case where the return address is illegally rewritten, when the instruction destination of the return address is in the area other than the text area or the shared library (the first area), the execution of the program is forcibly terminated such that the execution of the malicious program due to the buffer overflow can be prevented.

In this embodiment, high-speed processing can be performed since it is executed by the internal processing of the processor, it is not necessary to perform an individual correction work to the application program, and, moreover, it is not necessary to depend on the high-level language used to create the program.

### Embodiment 2

In this embodiment, a processing device is configured to comprise the stack area as the first area. The processing device is characterized by comprising a processor which obtains the memory map by executing the start-up routine; includes one set of a dedicated register set that stores the start address and the end address of the stack area obtained from the information indicated by the memory map; and includes an internal instruction to implement processing means.

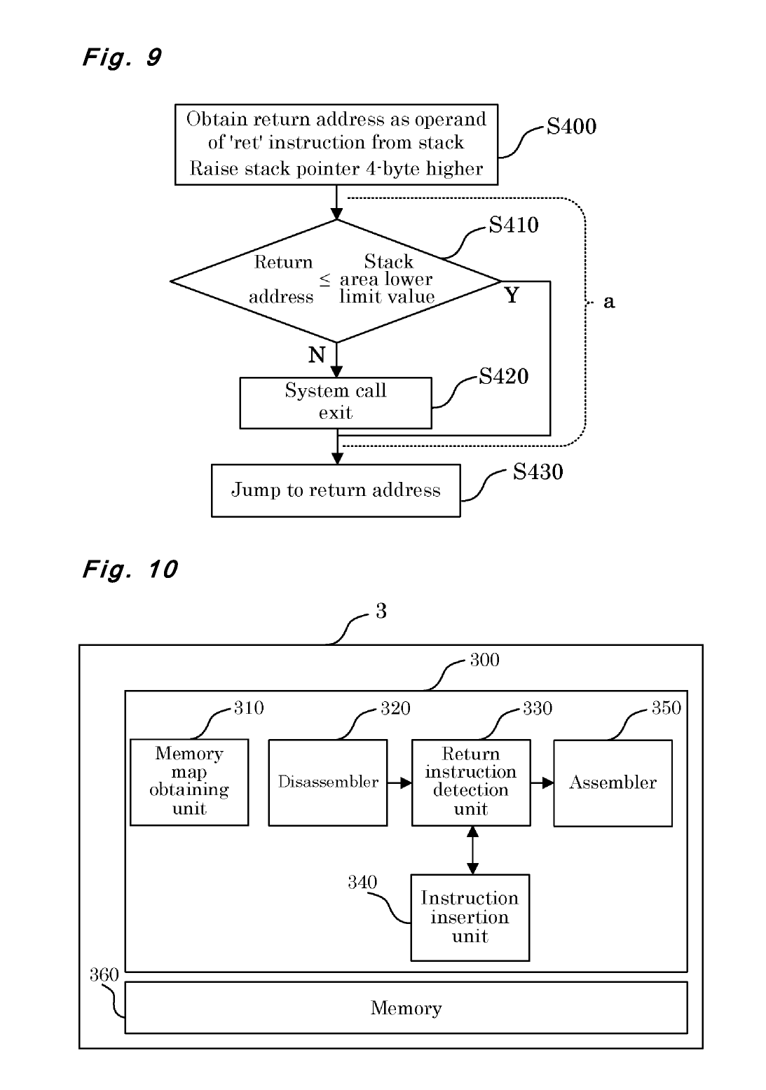

The internal instruction is a machine language instruction that executes a processing flow, which is illustrated in FIG. 9, corresponding to the mnemonic of the RET instruction.

FIG. 4 shows a block diagram illustrating the configuration of the processing device 1.

The processor 100 according to this embodiment includes, in addition to the general-purpose register 121, the dedicated register set 122 constituted of one set of the start register 123 that stores the start address of the stack area and the end register 124 that stores the end address of the stack area. Since the stack area is one consecutive area, one set of the dedicated register set 122 is enough.

The processing device 1 can include, although not shown in the drawings, the input/output device with the outside, the storage device, the display device, and the like.

In this embodiment, it is characterized in that the start address and the end address of the stack area on the memory are obtained from the information indicated by the memory map before the main processing of the application program is executed.

In the following, a processing step of obtaining the start address and the end address of the stack area from the information indicated by the memory map will be explained.

FIG. 8 shows a flowchart illustrating a procedure that the processing device 1, which is illustrated in FIG. 4, obtains the start address and the end address of the stack area by the start-up routine.

Before executing the main processing of the application program, the processing device 1 executes the start-up routine linked to the execution file of the application program such that the processing device 1 obtains the memory map for the execution file of the application program (Step S300). The memory map is sorted in the ascending order, from the lower to higher start address (Step S310).

The memory map includes the information shown in FIG. 3. The determination is executed in the order from the head of the memory map (Step S320). Since the stack area is configured to be set as the consecutive area up to the highest address, the last line of the memory map is referred (Step S330). The end register 124 stores the end address (Step S330). In this embodiment, the register set is the first storage means.

The processing device 1 obtains a stack size upper limit value of this process (Step S350). In the case of Linux (registered trademark), the stack size upper limit value can be confirmed with an instruction such as ulimit-a (in the case where the shell script is bash). A difference value (a stack area lower limit value) between the stack size upper limit value and the end address of the stack area obtained by operation in hexadecimal is stored in the start register 123 as the start address of the stack area (Step S360).

The reason why the start address indicated by the memory map is not stored in the start register 123 directly is that the size of the stack area may be dynamically changed, but it should not be changed exceeding the upper limit value. In this embodiment, the stack area lower limit value and the end address of the stack area are the first specification information.

Next, FIG. 9 shows a flowchart illustrating a procedure for processing executed by the operating unit 120 in the processor 100, which is illustrated in FIG. 4. Compared with the processing by the RET instruction, which allows the return destination to return to any area in the process space, the processing of the part denoted by a in FIG. 9 is added to the processing by the RET instruction in this embodiment.

Next, processing steps of detecting the RET instruction and obtaining the return address instructed as the operand will be explained.

With the processing device 1 illustrated in FIG. 4, the application program loaded from the storage device or the input/output device from/to the outside is stored, as the execution instruction translated into the machine language, in the text area in the memory 150. In the control unit 110 of the processor 100, the execution instruction is obtained by a fetch 111 and goes through a decoder 112 such that control information is transmitted to an operating unit 120. With this respect, in the case where the operating unit 120 detects the RET instruction, the return address instructed as the operand of the RET instruction is obtained.

Next, a processing step of determining which area on the memory the return address instructs will be explained.

After the operating unit 120 in the processing device 1 obtains the return address instructed as the operand of the RET instruction (Step S400), it is determined whether the start address stored in the start register 123 is larger or smaller than the value of the return address (Step S410). If the return address is larger than or equal to the stack area lower limit value, it is determined that the return address instructs the stack area.

Next, a processing step of preventing the execution of malicious program beforehand in the case where the return address instructs an illegal area on the memory.

In the case where the return address is smaller than the stack area lower limit value, the processing jumps to the return address (Step S430) while, if the return address is greater than or equal to the stack area lower limit value, the execution of the program is forcibly terminated (Step S420).

As described above, according to this embodiment, in the case where the return address is illegally rewritten, if the instruction destination of the return address is in the stack area, the execution of the program is forcibly terminated such that the execution of the malicious program due to the buffer overflow may be prevented.

Also, the internal processing of the processor allows such high-speed processing as well as eliminates the necessity for individual correction work to each application program and the dependency on the high-level language used to create the program.

Compared with Embodiment 1, limited to the case where the malicious program has been written to the stack area, it is characterized in that the one set of dedicated register set is enough.

### Embodiment 3

This embodiment provides a processing device configured to comprise an area other than the text area or the shared library as the first area. In this embodiment, it is characterized in that, if the return address is illegally rewritten due to the buffer overflow, an instruction is added to the assembly code of the application program in order to prevent the execution of the malicious program beforehand.

FIG. 10 shows a block diagram illustrating a configuration of a processing device 3 according to this embodiment. The processing device 3 is a device that includes a processor 300, a memory map obtaining unit 310, a disassembler 320, a return instruction detecting unit 330, an instruction insertion unit 340, an assembler 350, and a memory 360.

In this embodiment, it operates before executing the execution file of the application program.

The memory map obtaining unit 310 obtains the start addresses and the end addresses of the text area and the shared library from the information indicated by the memory map. In this embodiment, the start addresses and the end addresses of the text area and the shared library are the first specification information.

The return instruction detecting unit 330 detects the RET instruction.

The instruction insertion unit 340 inserts a return address acquisition instruction to obtain the return address instructed as the operand of the RET instruction; a determination instruction to determine which area on the memory is instructed with the return address; and a forcible termination instruction to prevent the execution of the malicious program beforehand in the case where the return address instructs an illegal area on the memory.

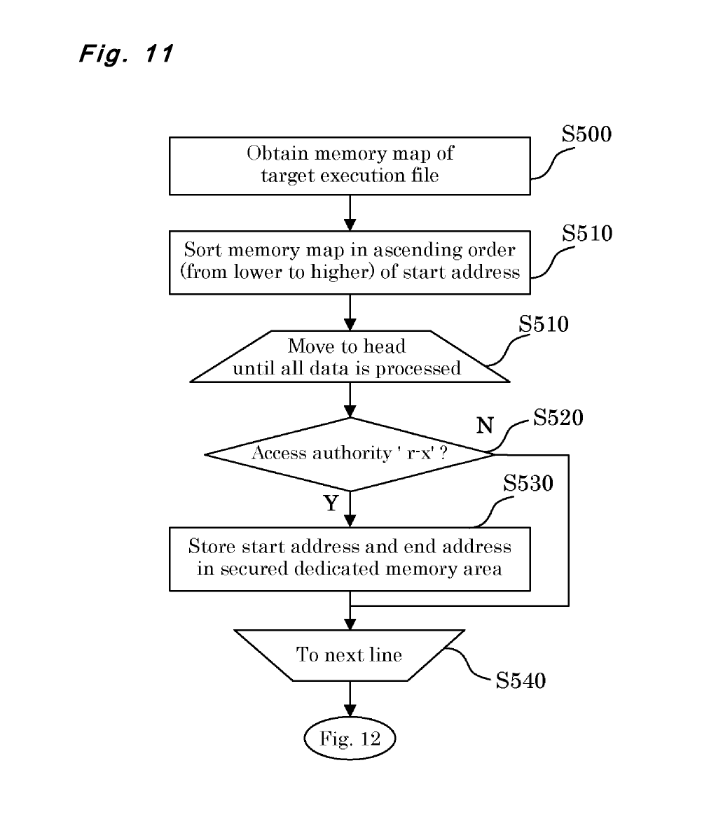

FIG. 11 shows a flowchart illustrating a procedure where the memory map obtaining unit 310 obtains the start addresses and the end addresses of the text area and the shared library in the processing device 3.

The processing device 3 obtains the memory map of the execution file of the application program to be executed (Step S500). The memory map is sorted in the ascending order, from the lower to higher start address (Step S510). The memory map includes the information shown in FIG. 3. The determination is executed in the order from the head of the memory map (Step S520). In the case of the access authority being “r-x” (readable, unwritable, and executable), it is determined that the area is the text area or the shared library (Step S720). Areas to save the return address are secured on the memory 360 and then the start addresses and the end addresses are stored on the memory 360 (Step S540). In this embodiment, the memory is the first storage means.

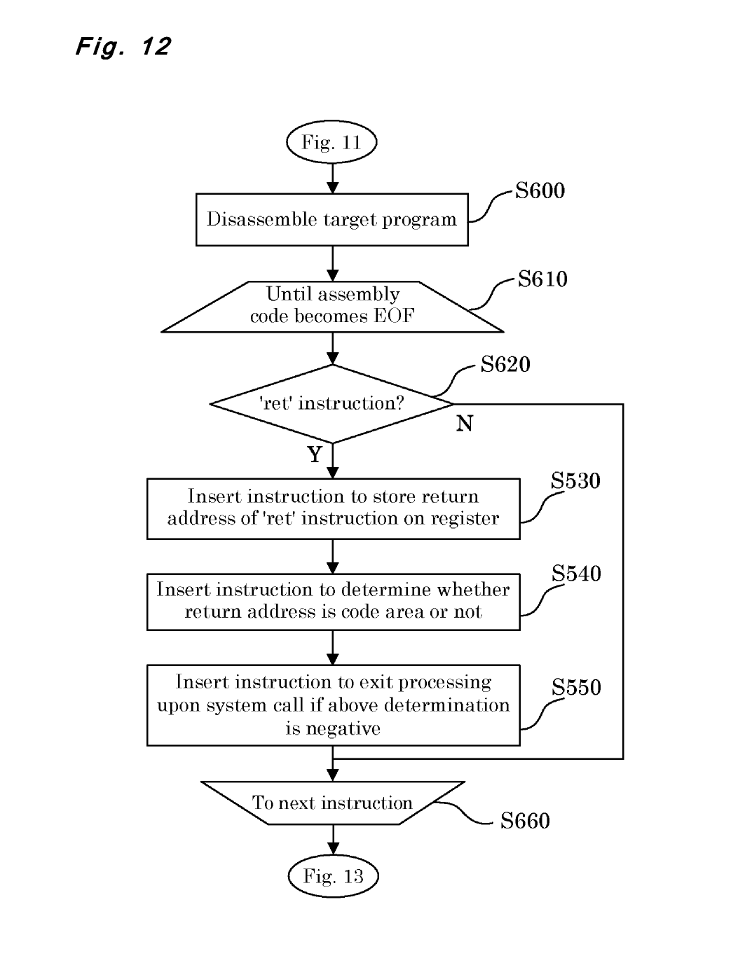

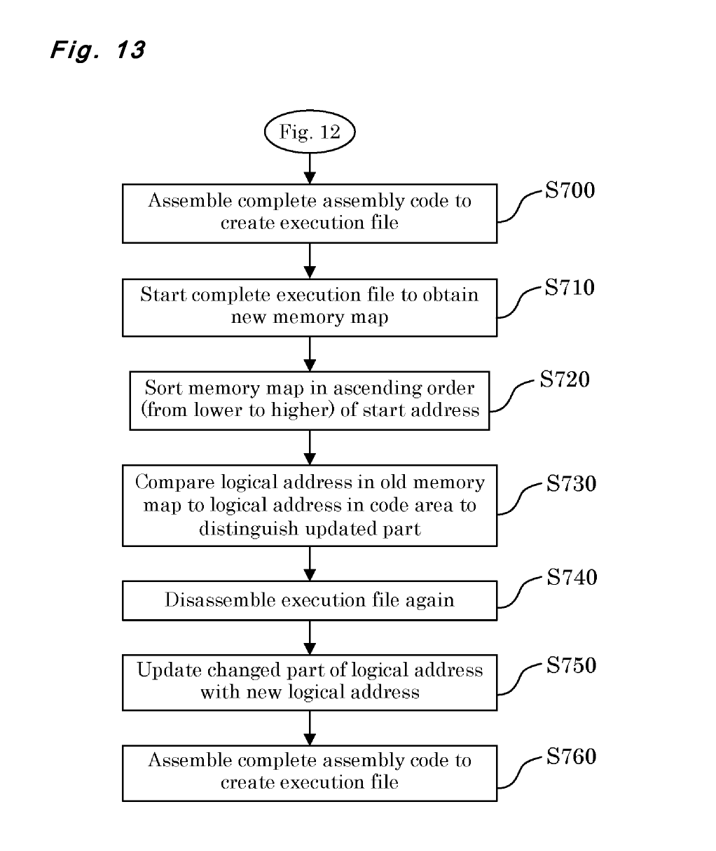

FIGS. 12 and 13 show flowcharts showing a procedure for processing executed by the disassembler 320, the return instruction detecting unit 330, the instruction insertion unit 340, and the assembler 350.

The processing device 3 disassembles the target application program by the disassembler 320 (Step S600).

Afterwards, the return instruction detecting unit 330 determines whether the instruction is the RET instruction or not (Step S620). When determined as the RET instruction, the processing is passed to the instruction insertion unit 340.

The instruction insertion unit 340 in the processing device 3 inserts the following three instructions before the RET instruction of the assembly code of the application program.

First, the instruction insertion unit 340 inserts the return address acquisition instruction to obtain the return address instructed as the operand of the RET instruction (Step S630).

Next, the instruction insertion unit 340 inserts the determination instruction to determine whether the return address indicates the text area or the shared library (Step S640).

The determination whether the return address indicates the text area or the shared library depends on the determination whether or not the return address is in the range between the start addresses and the end addresses of the text area and the shared library stored in the areas for saving the return address.

Next, if the return address does not indicate the text area or the shared library, the instruction insertion unit 340 inserts the forcible termination instruction, which forcibly terminates the program (Step S650). The case where the instruction destination of the return address is in an area other than the text area or the shared library (the first area) is the case where the return address is neither in the range at least the start address and not exceeding the end address of the text area nor in the range at least the start address and not exceeding the end address of the shared library.

As illustrated in FIG. 12, as the instruction insertion unit 340 inserts the instructions (Step S640 and Step S650), the text area is expanded. Accordingly, as illustrated in FIG. 13, after an assembly code into which an instruction has been inserted is converted into the execution file by assembler (Step S700), it is updated in accordance with the start address and the end address of the text area retrieved again from the memory map obtained from the disassembled assemble code (Step S740). Afterwards, the assembler 350 assembles the assemble code to complete the execution file of the target application program (Step S760).

As described above, according to this embodiment, in the case where the return address is illegally rewritten, when the instruction destination of the return address is not in any of the text area or the shared library, the instruction is added to the application program so as to forcibly terminate the execution of the program such that the application program may be converted into a program that can prevent the execution of the malicious program due to the buffer overflow beforehand.

Additionally, in this embodiment, since the processing device automatically adds the instruction to the assembly code, it is not necessary to perform individual correction work to each application program or depend on the high-level language used to create the program.

### Embodiment 4

This embodiment provides a processing device configured to comprise the stack area as the first area. In this embodiment, it is characterized in that, if the return address is illegally rewritten due to the buffer overflow, an instruction is added to the assembly code of the application program in order to prevent the execution of the malicious program beforehand.

FIG. 10 shows a block diagram illustrating the configuration of the processing device 3 according to the embodiment. The processing device 3 is the device that includes the processor 300, the memory map obtaining unit 310, the disassembler 320, the return instruction detecting unit 330, the instruction insertion unit 340, the assembler 350, and the memory 360.

In this embodiment, it operates before executing the execution file of the application program.

The memory map obtaining unit 310 obtains the start address and the end address of the stack area from the information indicated by the memory map.

The return instruction detecting unit 330 detects the RET instruction.

The instruction insertion unit 340 inserts a return address acquisition instruction to obtain the return address instructed as the operand of the RET instruction; a determination instruction to determine which area on the memory is instructed with the return address; and a forcible termination instruction to prevent the execution of the malicious program beforehand in the case where the return address indicates an illegal area on the memory.

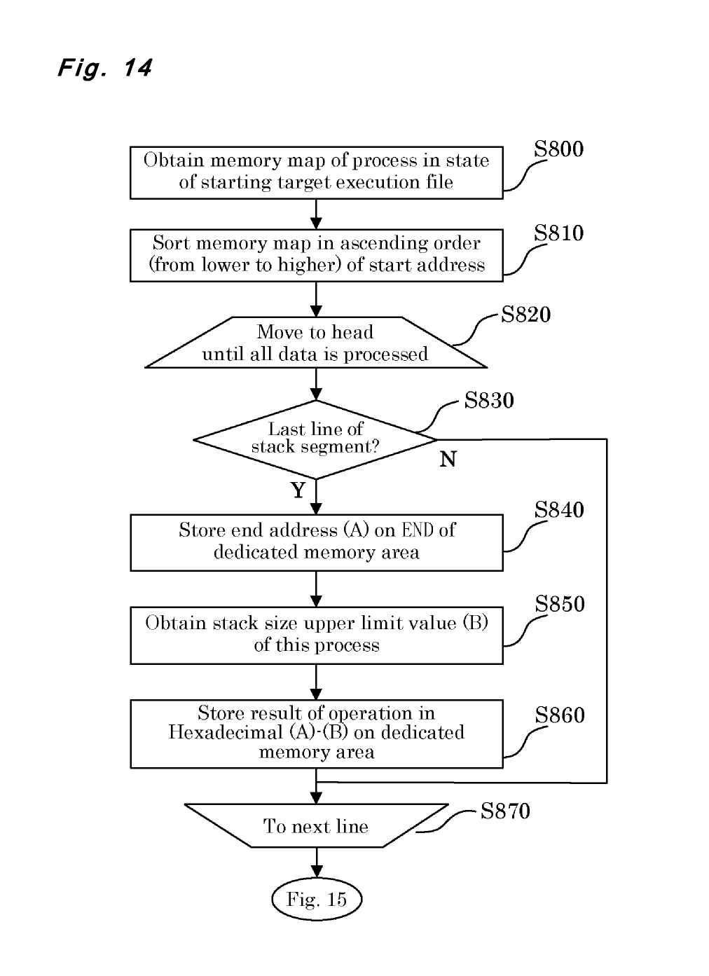

FIG. 14 shows a flowchart illustrating a procedure where the memory map obtaining unit 310 obtains the start address and the end address of the stack area in the processing device 3.

The processing device 3 obtains the memory map of the execution file of the application program to be executed (Step S800). The memory map is sorted in the ascending order, from the lower to higher start address (Step S810). The memory map includes the information shown in FIG. 3. The determination is executed in the order from the head of the memory map (Step S820). Since the stack area is made to be a consecutive area up to the highest address, the last line of the memory map is referred to (Step S830). After an area for saving the return address is secured on the memory 360, the end address is stored (Step S840).

Next, the processing device 3 obtains the stack size upper limit value in the process (Step S850). In the case of Linux (registered trademark), the stack size upper limit value can be confirmed with an instruction such as “ulimit-a” (in the case where the shell script is bash). The area for saving the difference value (the stack area lower limit value) between the stack size upper limit value and the end address of the stack area obtained by operation in hexadecimal is secured on the memory 360 and then the memory 360 stores the difference value (Step S860). In this embodiment, the memory is the first storage means.

The reason why the start address indicated by the memory map is not directly stored in the area for saving the return address is that the size of the stack area may be dynamically changed, but it should not be changed exceeding the upper limit value. In this embodiment, the stack area lower limit value and the end address of the stack area are the first specification information.

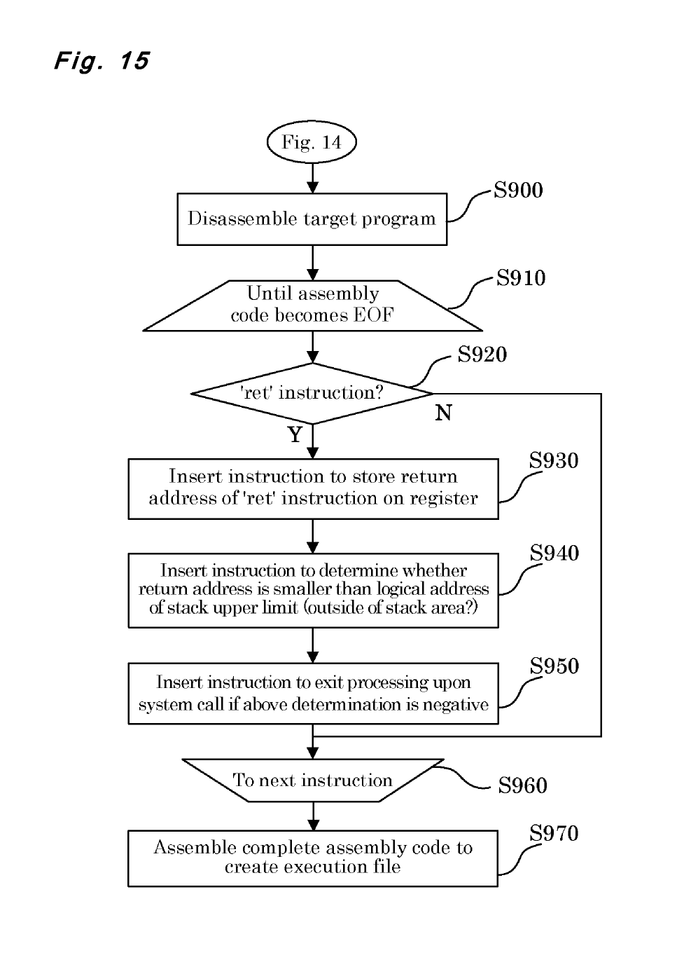

FIG. 15 shows a flowchart illustrating a procedure for processing executed by a disassembler 420, an instruction insertion unit 430, and an assembler 440.

The processing device 3 disassembles the target application program by the disassembler 420 (Step S900).

Afterwards, the return instruction detecting unit 330 determines whether the instruction is the RET instruction or not (Step S920). When determined as the RET instruction, the processing is passed to the instruction insertion unit 430.

The instruction insertion unit 430 in the processing device 3 inserts the following three instructions before the RET instruction for the assembly code of the application program.

First, the instruction insertion unit 430 inserts the return address acquisition instruction to obtain the return address instructed as the operand of the RET instruction (Step S930).

Next, the instruction insertion unit 430 inserts the determination instruction to determine whether the return address instructs the stack area or not (Step S940).

With respect to determination whether the return address instructs the stack area or not, it is determined that the return address instructs the stack area when the return address is greater than or equal to the stack area lower limit value.

Next, if the return address instructs the stack area, the instruction insertion unit 430 inserts the forcible termination instruction, which forcibly terminates the program (Step S950). This prevents the execution of the malicious program beforehand in the case where the return address instructs an illegal area on the memory.

As described above, according to this embodiment, in the case where the return address is illegally rewritten, if the instruction destination of the return address is in the stack area, the instruction is added to the application program so as to forcibly terminate the execution of the program such that the execution of the malicious program due to the buffer overflow may be prevented beforehand.

Additionally, in this embodiment, since the processing device automatically adds the instruction to the assembly code, it is not necessary to perform individual correction work to each application program or to depend on the high-level language used to create the programs.

Although limited to the case where the malicious program has been written to the stack area, compared with Embodiment 3, in this embodiment, it is characterized in that the execution size of the program is so small that update processing may be fast.

### INDUSTRIAL APPLICABILITY

The present invention allows preventing an execution of a malicious program beforehand due to a buffer overflow.

### DESCRIPTION OF REFERENCE SIGNS

| | |
|---|---|
| 1 | processing device |
| 100 | processor |
| 110 | control unit |
| 111 | fetch unit |
| 112 | decoding unit |
| 120 | operating unit |
| 121 | general-purpose register |
| 122 | dedicated register set |
| 123 | start register |
| 124 | end register |
| 125 | calculator |
| 150 | memory |
| 3 | processing device |
| 300 | processor |
| 310 | memory map obtaining unit |
| 320 | disassembler |
| 330 | return instruction detecting unit |
| 340 | instruction insertion unit |
| 350 | assembler |

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

1. A processor having a function to allocate a process space in a memory before executing main processing, the processor executing processing including a return instruction for returning to a return destination in any area in the process space, the processor comprising:
means for obtaining first specification information for specifying a first area in the process space;
first storage means for storing the first specification information;
return instruction detecting means for detecting a return instruction from the processing in advance;
means for obtaining address information for specifying a place of returning by the return instruction;
means for determining whether the place specified by the address information is in the first area or not based on the first specification information; and
means for interrupting the processing if the determining means determines that the specified place is in the first area.

2. The processor according to claim 1, wherein the first storage means includes a register.

3. The processor according to claim 1, wherein the first area is another area other than a text area or a shared library in the process space.

4. The processor according to claim 1, wherein the first area is a stack area in the process space.

5. A processing device, comprising:
the processor recited in claim 1;
the memory; and
communication means for enabling communication between the processor and the memory.

6. A method of making an executable program using a computer, the executable program being configured to implement a method to cause a processor to execute processing, the processor having a function to allocate a process space in a memory before executing main processing, the processor executing the processing including a return instruction for returning to a return destination in any area in the process space, the method comprising the computer's rewriting the return instruction so as to cause the processor to implement the steps of:
obtaining first specification information for specifying a first area in the process space;
storing the first specification information;
detecting a return instruction from the processing in advance;
obtaining address information for specifying a place of returning by the return instruction;
determining whether the place specified by the address information is in the first area or not based on the first specification information; and
interrupting the processing by the processor if the determining means determines that the specified place is in the first area.

7. The method of making the executable program according to claim 6, further comprising the steps of:
the computer's converting the executable program into an assembly language before the rewriting step,
wherein the rewriting of the return instruction is performed in the assembly language in the rewriting step; and
converting the converted executable program into an executable format after the rewriting.

8. The processor according to claim 2, wherein the first area is another area other than a text area or a shared library in the process space.

9. The processor according to claim 2, wherein the first area is a stack area in the process space.

10. The processing device according to claim 5, wherein the first storage means includes a register.

11. The processing device according to claim 5, wherein the first area is another area other than a text area or a shared library in the process space.

12. The processing device according to claim 5, wherein the first area is a stack area in the process space.

13. A processor having a function to allocate a process space in a memory before executing main processing, the processor executing processing including a return instruction for returning to a return destination in any area in the process space, the processor comprising:
a memory-map obtaining unit to obtain first specification information for specifying a first area in the process space;
a register to store the first specification information;
a return instruction detecting unit to detect a return instruction from the processing in advance;
a fetch unit to obtain address information for specifying a place of returning by the return instruction;
an operating unit to determine, based on the first specification information, whether the place specified by the address information is in the first area or not; and
an instruction insertion unit to insert a forcible termination to interrupt the processing if the determining means determines that the specified place is in the first area.
